(19) United States
(12) Patent Application Publication
(10) Pub. No.: US 2024/0101465 A1
(43) Pub. Date: Mar. 28, 2024

(54) OPTICAL GLASS, OPTICAL ELEMENT, OPTICAL SYSTEM, CEMENTED LENS, INTERCHANGEABLE CAMERA LENS, MICROSCOPE OBJECTIVE LENS, AND OPTICAL DEVICE

(71) Applicant: HIKARI GLASS CO., LTD., Yuzawa-shi (JP)

(72) Inventor: Noriaki IGUCHI, Yokote-shi (JP)

(73) Assignee: HIKARI GLASS CO., LTD., Yuzawa-shi (JP)

(21) Appl. No.: 18/522,881

(22) Filed: Nov. 29, 2023

Related U.S. Application Data
(63) Continuation of application No. PCT/JP2022/022611, filed on Jun. 3, 2022.

(30) Foreign Application Priority Data
Jun. 7, 2021 (JP) 2021-095258

(51) Int. Cl. C03C 3/095; G02B 21/36; G03B 17/14

(52) U.S. Cl. CPC C03C 3/095; G02B 21/362; G03B 17/14

(57) ABSTRACT

Provided is an optical glass including, by mass %, 33 to 60% of a content rate of SiO₂, 10 to 35% of a content rate of TiO₂, and 15 to 40% of a content rate of Na₂O, wherein a refractive index n_{d} with respect to a d-line is 1.71 or less.

### TECHNICAL FIELD

The present invention relates to an optical glass, an optical element, an optical system, a cemented lens, an interchangeable camera lens, a microscope objective lens, and an optical device. The present invention claims priority to Japanese Patent Application No. 2021-095258, filed on Jun. 7, 2021, the contents of which are incorporated by reference herein in its entirety in designated states where the incorporation of documents by reference is approved.

### BACKGROUND ART

For example, PTL 1 discloses an SiO₂—B₂O₃—Nb₂O₅-based optical glass as an optical glass that can be used for an optical element used in an optical device such as a camera.

PTL 1: JP 2017-88484 A

### SUMMARY

A first aspect according to the present invention is an optical glass including, by mass %, 33 to 60% of a content rate of SiO₂, 10 to 35% of a content rate of TiO₂, and 15 to 40% of a content rate of Na₂O, wherein a refractive index n_{d} with respect to a d-line is 1.71 or less. Further, provided is an optical glass including, by mass %, 33 to 60% of a content rate of SiO₂, 10 to 35% of a content rate of TiO₂, 15 to 40% of a content rate of Na₂O, and more than 0% and 1% or less of a content rate of Sb₂O₃, wherein a refractive index n_{d} with respect to a d-line is 1.71 or less. Further, provided is an optical glass including, by mass %, 33 to 60% of a content rate of SiO₂, 10 to 35% of a content rate of TiO₂, 15 to 40% of a content rate of Na₂O, wherein a ratio of a content rate of TiO₂ to a content rate of Na₂O (TiO₂/Na₂O) is 1.0 or less, a refractive index n_{d} with respect to a d-line is from 1.605 to 1.634, and an abbe number (ν_{d}) is 38.5 or less. Further, provided is an optical glass including, by mass %, 33 to 60% of a content rate of SiO₂, 10 to 35% of a content rate of TiO₂, 15 to 40% of a content rate of Na₂O, wherein a refractive index n_{d} with respect to a d-line is 1.71 or less, abnormal dispersibility (ΔP_{g, F}) is 0.0060 or less, and specific gravity (S_{g}) is 3.10 or less. Further, provided is an optical glass including, by mass %, 33 to 60% of a content rate of SiO₂, 10 to 35% of a content rate of TiO₂, 15 to 40% of a content rate of Na₂O, wherein a ratio of a content rate of TiO₂ to a content rate of Na₂O (TiO₂/Na₂O) is 1.0 or less, and a total content rate of SiO₂ and Na₂O (SiO₂+Na₂O) is from 76% to 80%. Provided is an optical glass including, by mass %, 33 to 60% of a content rate of SiO₂, 10 to 35% of a content rate of TiO₂, 15 to 40% of a content rate of Na₂O, wherein a ratio of a content rate of TiO₂ to a content rate of Na₂O (TiO₂/Na₂O) is 1.0 or less, a ratio of a content rate Na₂O to a total content rate of SiO₂, Na₂O, and TiO₂ (SiO₂+TiO₂+Na₂O) (Na₂O/(SiO₂+TiO₂+Na₂O)) is from 0.25 to 0.27. Further, provided is an optical glass including, by mass %, 33 to 60% of a content rate of SiO₂, 10 to 35% of a content rate of TiO₂, 15 to 40% of a content rate of Na₂O, wherein a total content rate of SiO₂, TiO₂, and Na₂O (SiO₂+TiO₂+Na₂O) is 75% or more, a total content rate of SiO₂ and Na₂O (SiO₂+Na₂O) is from 55 to 85%, and a ratio of a content rate of TiO₂ to a content rate of Na₂O (TiO₂/Na₂O) is from 0.3 to 1.6. Note that the refractive index (n_{d}) with respect to the d-line is a value obtained through measurement by the V-block method or the minimum deviation method.

A second aspect according to the present invention is an optical element using the optical glass described above.

A third aspect according to the present invention is an optical system including the optical element described above.

A fourth aspect according to the present invention is an interchangeable camera lens including the optical system including the optical element described above.

A fifth aspect according to the present invention is a microscope objective lens including the optical system including the optical element described above.

A sixth aspect according to the present invention is an optical device including the optical system including the optical element described above.

A seventh aspect according to the present invention is a cemented lens including a first lens element and a second lens element, wherein at least one of the first lens element and the second lens element includes the optical glass described above.

An eighth aspect according to the present invention is an optical system including the cemented lens described above.

A ninth aspect according to the present invention is a microscope objective lens including the optical system including the cemented lens described above.

A tenth aspect according to the present invention is an interchangeable camera lens including the optical system including the cemented lens described above.

An eleventh aspect according to the present invention is an optical device including the optical system including the cemented lens described above.

### BRIEF DESCRIPTION OF THE DRAWINGS

FIG. 1 is a perspective view illustrating one example of an optical device according to the present embodiment as an imaging device;

FIG. 2 is a schematic view illustrating another example of the optical device according to the present embodiment as an imaging device, which is a front view of the imaging device;

FIG. 3 is a schematic view illustrating another example of the optical device according to the present embodiment as an imaging device, which is a back view of the imaging device;

FIG. 4 is a block diagram illustrating one example of a configuration of a multi-photon microscope according to the present embodiment;

FIG. 5 is a schematic diagram illustrating one example of a cemented lens according to the present embodiment; and

FIG. 6 is a graph in which P_{g, F} and ν_{d} in each example and each comparative example are plotted.

### DETAILED DESCRIPTION

Hereinafter, description is made on an embodiment of the present invention (hereinafter, referred to as the “present embodiment”). The present embodiment described below is an example for describing the present invention, and is not intended to limit the present invention to the contents described below. The present invention may be modified as appropriate and carried out without departing from the gist thereof.

In the present specification, a content rate of each of all the components is expressed with mass % (mass percentage) with respect to the total weight of glass in terms of an oxide-converted composition unless otherwise stated. Note that, assuming that oxides, complex salt, and the like, which are used as raw materials as glass constituent components in the present embodiment, are all decomposed and turned into oxides at the time of melting, the oxide-converted composition described herein is a composition in which each component contained in the glass is expressed with a total mass of the oxides as 100 mass %.

The expression that a content rate of Q is “from 0 to N %” is an expression including a case in which the component Q is excluded and a case in which a content rate of the component Q is more than 0% and N % or less.

The expression “devitrification resistance stability” indicates resistance of the glass with respect to devitrification. Here, “devitrification” indicates a phenomenon where transparency of the glass is lost due to crystallization, phase separation, or the like that occurs when the glass is heated to a temperature equal to or higher than the glass transition temperature or when the glass is cooled from a molten state to a temperature equal to or lower than the liquidus temperature.

The optical glass according to the present embodiment is an optical glass including, by mass %, 33 to 60% of a content rate of SiO₂, 10 to 35% of a content rate of TiO₂, and 15 to 40% of a content rate of Na₂O, wherein a refractive index n_{d} with respect to a d-line is 1.71 or less. Further, the optical glass according to the present embodiment is an optical glass including, by mass %, 33 to 60% of a content rate of SiO₂, 10 to 35% of a content rate of TiO₂, 15 to 40% of a content rate of Na₂O, and more than 0% and 1% or less of a content rate of Sb₂O₃, wherein a refractive index n_{d} with respect to a d-line is 1.71 or less. Further, the optical glass according to the present embodiment is an optical glass including, by mass %, 33 to 60% of a content rate of SiO₂, 10 to 35% of a content rate of TiO₂, 15 to 40% of a content rate of Na₂O, wherein a total content rate of SiO₂, TiO₂, and Na₂O (SiO₂+TiO₂+Na₂O) is 75% or more, a total content rate of SiO₂ and Na₂O (SiO₂+Na₂O) is from 55 to 85%, and a ratio of a content rate of TiO₂ to a content rate of Na₂O (TiO₂/Na₂O) is from 0.3 to 1.6.

An optical glass with small ΔP_{g, F} being a value indicating abnormal dispersibility while achieving high dispersion has been required in order to improve a degree of freedom in design of an optical system such as an optical device. A composition including a large amount of the Nb₂O₅ component, which is expensive in general, is required in order to produce an optical glass with small ΔP_{g, F}. Since a large amount of the Nb₂O₅ component is included, it is difficult to reduce an abbe number (ν_{d}) while maintaining a refractive index (n_{d}) in a small value with respect to a d-line.

The optical glass according to the present embodiment may be a low specific gravity optical glass with specific gravity of 3.10 or less.

Description is made below on a component of the optical glass according to the present embodiment.

SiO₂ is a component that forms a glass frame and reduces ΔP_{g, F} while maintaining a refractive index in a small value. When a content rate of the component is excessively low, devitrification resistance stability of the glass is insufficient. When the content rate is excessively high, meltability of the glass is reduced, and viscosity of the glass itself is increased. As a result, the molding is difficult. In view of this, a content rate of SiO₂ is from 33 to 60%. A lower limit of this content rate is preferably 34%, more preferably 36%, further preferably 47.3%, further more preferably 47.5%. An upper limit of this content rate is preferably 58%, more preferably 55%, further preferably 54%.

TiO₂ is a component that increases a refractive index of the glass and achieves high dispersion, but when a content rate of the component is excessively high, n_{d} and ΔP_{g, F} are significantly increased, degrading also a transmittance. In view of this, the content rate of TiO₂ is from 10 to 35%. A lower limit of this content rate is preferably 11%, more preferably 14%, further preferably 20%. An upper limit of this content rate is preferably 34%, more preferably 32%, further preferably 29%.

Na₂O is a component that improves meltability of the raw materials and reduces ΔP_{g, F} while achieving a low refractive index and high dispersion. When a content rate of the component is excessively high, chemical durability is reduced, and devitrification resistance stability is also reduced. In view of this, the content rate of Na₂O is from 15 to 40%. A lower limit of this content rate is preferably 17%, more preferably 19%, further preferably 21%. An upper limit of this content rate is preferably 38%, more preferably 37%, further preferably 36%.

The optical glass according to the present embodiment may further include one or more components selected from a group consisting of B₂O₃, La₂O₃, Gd₂O₃, Y₂O₃, ZrO₂, Nb₂O₅, MgO, Ta₂O₅, ZnO, BaO, CaO, SrO, Al₂O₃, WO₃, Li₂O, K₂O, and Sb₂O₃, as an optional component.

Further, a more preferable combination of the components described above is 0 to 10% of a content rate of B₂O₃, 0 to 5% of a content rate of La₂O₃, 0 to 5% of a content rate of Gd₂O₃, 0 to 5% of a content rate of Y₂O₃, 0 to 20% of a content rate of ZrO₂, 0 to 25% of a content rate of Nb₂O₅, 0 to 5% of a content rate of MgO, 0 to 10% of a content rate of Ta₂O₅, 0 to 25% of a content rate of ZnO, 0 to 5% of a content rate of BaO, 0 to 5% of a content rate of CaO, 0 to 5% of a content rate of SrO, 0 to 5% of a content rate of Al₂O₃, 0 to 5% of a content rate of WO₃, 0 to 5% of a content rate of Li₂O, 0 to 10% of a content rate of K₂O, and 0 to 1% of a content rate of Sb₂O₃.

B₂O₃ is a component that forms a glass frame and improves chemical durability. When a content rate of the component is excessively high, high dispersion is achieved, and ΔP_{g, F} is increased at the same time. In view of this, the content rate of B₂O₃ is from 0 to 10%. A lower limit of this content rate is preferably more than 0%, more preferably 1%, further preferably 3%. An upper limit of this content rate is preferably less than 10%, more preferably 8%, further preferably 7%.

La₂O₃ is a component effective for adjusting a constant of the glass. In view of this, in a preferred aspect, a content rate of La₂O₃ may be from 0 to 5%. A lower limit of this content rate is more preferably more than 0%, further preferably 0.5%. An upper limit of this content rate is more preferably 4%, further preferably 3%.

Gd₂O₃ is a component effective for adjusting a constant of the glass. In view of this, in a preferred aspect, a content rate of Gd₂O₃ may be from 0 to 5%. A lower limit of this content rate is more preferably more than 0%, further preferably 0.5%. An upper limit of this content rate is more preferably 4%, further preferably 3%.

Y₂O₃ is a component effective for adjusting a constant of the glass. In view of this, in a preferred aspect, a content rate of Y₂O₃ may be from 0 to 5%. A lower limit of this content rate is more preferably more than 0%, further preferably 0.5%. An upper limit of this content rate is more preferably 4%, further preferably 3%.

ZrO₂ is a component that increases a refractive index of the glass and achieves high dispersion while suppressing increase of ΔP_{g, F}. When a content rate of the component is excessively high, meltability of the glass raw materials and devitrification resistance stability are reduced. In view of this, the content rate of ZrO₂ is from 0 to 20%. A lower limit of this content rate is preferably more than 0%, more preferably 4%, further preferably 8%, further more preferably 10%. An upper limit of this content rate is preferably 16%, more preferably 14%, further preferably 12%. ZrO₂ can be mutually substituted with SiO₂. When the content rate of ZrO₂ is increased by substituting ZrO₂ with SiO₂, a refractive index of the glass can be increased and high dispersion can be achieved while suppressing increase of ΔP_{g, F}.

Nb₂O₅ is a component that increases a refractive index of the glass and achieves high dispersion while suppressing increase of ΔP_{g, F}. When a content rate of the component is excessively high, a refractive index is increased. In view of further improving devitrification resistance stability and view of raw material costs, the content rate of Nb₂O₅ is from 0 to 25%. A lower limit of this content rate is preferably more than 0%, more preferably 5%, further preferably 8%. An upper limit of this content rate is preferably less than 25%, more preferably 23%, further preferably 20%, further more preferably less than 20%.

MgO is a component effective for adjusting a constant of the glass. In view of this, a content rate of MgO is preferably from 0 to 5%. A lower limit of this content rate is more preferably more than 0%, further preferably 0.5%. An upper limit of this content rate is more preferably 4%, further preferably 3%.

Ta₂O₅ is a component that increases a refractive index of the glass and achieves high dispersion while suppressing increase of ΔP_{g, F}. In view of further improving devitrification resistance stability and view of raw material costs, a content rate of Ta₂O₅ is preferably from 0 to 10%. A lower limit of this content rate is more preferably more than 0%, further preferably 0.5%, further more preferably 2%. An upper limit of this content rate is more preferably 8%, further preferably 7%, further more preferably 6%. Effects of Ta₂O₅ and those of ZrO₂ are similar. Thus, Ta₂O₅ can be mutually substituted with ZrO₂.

ZnO is a component that increases a refractive index of the glass and achieves high dispersion. When a content rate of the component is excessively high, a refractive index is increased. In view of further improving devitrification resistance stability, the content rate of ZnO is preferably from 0 to 25%. A lower limit of this content rate is more preferably more than 0%, further preferably 5%, further more preferably 10%. An upper limit of this content rate is more preferably 23%, further preferably 19%.

BaO is a component effective for adjusting a constant of the glass. In view of this, a content rate of BaO is preferably from 0 to 5%. A lower limit of this content rate is more preferably more than 0%, further preferably 0.5%. An upper limit of this content rate is more preferably 4%.

CaO is a component effective for adjusting a constant of the glass. In view of this, a content rate of CaO is preferably from 0 to 5%. A lower limit of this content rate is more preferably more than 0%, further preferably 0.5%. An upper limit of this content rate is more preferably 4%.

SrO is a component effective for adjusting a constant of the glass. In view of this, a content rate of SrO is preferably from 0 to 5%. A lower limit of this content rate is more preferably more than 0%, further preferably 0.5%. An upper limit of this content rate is more preferably 4%.

Al₂O₃ is a component effective for adjusting a constant of the glass. In view of this, a content rate of Al₂O₃ is preferably from 0 to 5%. A lower limit of this content rate is more preferably more than 0%, further preferably 0.5%. An upper limit of this content rate is more preferably 4%.

WO₃ is a component effective for adjusting a constant of the glass. In view of this, a content rate of WO₃ is preferably from 0 to 5%. A lower limit of this content rate is more preferably more than 0%, further preferably 0.5%. An upper limit of this content rate is more preferably 4%.

Li₂O is a component that increases a refractive index of the glass and improves meltability of the glass raw materials. When a content rate of the component is excessively high, devitrification resistance stability is reduced, and ΔP_{g, F} is increased. In view of this, the content rate of Li₂O is from 0 to 5%. A lower limit of this content rate is preferably more than 0%, more preferably 0.3%, further preferably 0.5%. An upper limit of this content rate is preferably 3.4%, more preferably 2.4%, further preferably 1.4%.

K₂O is a component that improves meltability of the raw materials and reduces ΔP_{g, F} while achieving a low refractive index and high dispersion, but when a content rate of the component is excessively high, low dispersion is caused, and chemical durability is also reduced. In view of this, the content rate of K₂O is preferably from 0 to 10%. A lower limit of this content rate is more preferably more than 0%, further preferably 0.5%, further more preferably 0.8%. An upper limit of this content rate is preferably 5%, more preferably 4%, further preferably 3%, further more preferably 2%. Note that K₂O can be mutually substituted with Na₂O.

Sb₂O₃ is a component that functions as a defoaming agent for clarifying the glass, but when a content rate of the component is excessively high, a transmittance is reduced. In view of this, the content rate of Sb₂O₃ is preferably from 0 to 1%. A lower limit of this content rate is more preferably more than 0%, further preferably 0.02%, further more preferably 0.03%. An upper limit of this content rate is more preferably 0.5%, further preferably 0.2%, further more preferably 0.1%. Sb₂O₃ may be mutually substituted with at least one of SiO₂, Na₂O, and TiO₂. Within the preferable range described above, the optical constant is not significantly changed.

In view of reducing a refractive index, some or all of the above-mentioned one, two, or more oxides may be substituted with fluorides. Fluorine (F) contained in fluorides reduces a refractive index of the glass, causes low dispersion, and increases ΔP_{g, F}. Therefore, a content rate of a mass of F (fluorine) by an outer percentage with respect to the total mass of the glass in terms of an oxide-converted composition is from 0 to 15%. Note that, in the present specification, a content rate of a mass of F (fluorine) by an outer percentage with respect to the total mass of the glass in terms of an oxide-converted composition indicates mass % (mass percentage) of a mass of fluorine (F) with respect to a total of a mass in terms of an oxide-converted composition, a mass of a cationic component of fluorides in terms of oxides, and a mass of fluorine (F), in other words, a mass of fluorine (F)/(a mass in terms of an oxide-converted composition+a mass of a cationic component of fluorides in terms of oxides+a mass of fluorine (F)). In other words, such a content rate is, when a total content rate of a mass of all the components other than fluorine (F) in terms of oxides is 100%, a mass of fluorine (F) expressed by mass % with respect to a total of a mass of all the components other than fluorine (F) in terms of oxides and a mass of fluorine (F). A lower limit of this content rate is preferably more than 0%, more preferably 4%, further preferably 8%. An upper limit of this content rate is preferably 13%, more preferably 10%, further preferably 9%. The glass may include fluorine by using, for example, K₂SiF₆, Na₂SiF₆, ZrF₄, AlF₃, NaF, CaF₂, LaF₃, or the like as a raw material of fluorides. For example, when K₂SiF₆ is used as a raw material, in which a cationic component of K₂SiF₆ is K and Si, a mass of a cationic component of fluorides in terms of oxides indicates an amount obtained by converting the masses of K and Si into K₂O and SiO₂.

Meanwhile, the optical glass according to the present embodiment can achieve a desired optical constant without including an element such as As, Pb, and Cd that has a large environmental load. In view of this, it is preferred that each of the elements As, Pb, and Cd be substantially excluded from the optical glass according to the present embodiment.

The optical glass according to the present embodiment is required to have a satisfactory transmittance and not to emit fluorescence. It is preferred that adding of elements such as Fe, Ni, Cr, Mn, Ag, Cu, Mo, Eu, and Au that cause coloring or fluorescence be avoided intentionally from the stage of blending the raw materials, and it is further preferred that the elements be substantially excluded.

Note that, in the present specification, “substantially excluded” indicates that the component is not contained as a constituent component that affects a property of a glass composition beyond a concentration in which the component is inevitably contained as an impurity. An allowable ratio of impurities varies depending on the raw materials. Thus, for example, when a content amount is less than 40 ppm, preferably less than 30 ppm, more preferably less than 10 ppm, further more preferably less than 8 ppm, such a content amount is regarded to be substantially absent.

An optional component may be added to the optical glass according to the present embodiment so as to satisfy the following conditions.

In view of preventing increase of ΔP_{g, F}, a ratio of a total content rate of B₂O₃, K₂O, and Al₂O₃ to a content rate of Na₂O ((B₂O₃+K₂O+Al₂O₃)/Na₂O) is preferably from 0 to 0.5. A lower limit of this ratio is more preferably more than 0, further preferably 0.10, further more preferably 0.15. An upper limit of this ratio is more preferably 0.34, further preferably 0.22, further more preferably 0.20.

In view of further improving meltability of the glass raw materials and devitrification resistance stability and achieving high dispersion, a total content rate of K₂O and Al₂O₃ (K₂O+Al₂O₃) is preferably from 0 to 10%. A lower limit of this total content rate is more preferably more than 0%, further preferably 0.10%, further more preferably 0.15%. An upper limit of this total content rate is preferably 5%, more preferably 4.1%, further preferably 2.8%, further more preferably 1.8%.

In view of further improving meltability of the glass raw materials and devitrification resistance stability and achieving high dispersion, a total content rate of MgO, CaO, SrO, and BaO (MgO+CaO+SrO+BaO) is preferably from 0 to 10%. A lower limit of this total content rate is more preferably more than 0%, further preferably 1%, further more preferably 1.4%. An upper limit of this total content rate is preferably 5%, more preferably 3.5%, further preferably 2%, further more preferably less than 1.5%.

In view of further improving meltability of the glass raw materials and devitrification resistance and achieving high dispersion, a total content rate of La₂O₃, Gd₂O₃, and Y₂O₃ (La₂O₃+Gd₂O₃+Y₂O₃) is preferably from 0 to 10%. A lower limit of this total content rate is more preferably more than 0%, further preferably 1%, further more preferably 1.5%. An upper limit of this total content rate is preferably 5%, more preferably 4%, further preferably 3%, further more preferably 2%.

In view of further improving meltability of the glass raw materials and devitrification resistance stability and achieving high dispersion, a total content rate of Li₂O, Na₂O, and K₂O (Li₂O+Na₂O+K₂O) is preferably from 15 to 40%. A lower limit of this total content rate is more preferably 15%, further preferably 17%, further more preferably 19%. An upper limit of this total content rate is more preferably 35%, further preferably 32%, further more preferably 30%.

In view of improving and devitrification resistance stability and reducing ΔP_{g, F}, a ratio of a content rate of B₂O₃ to a content rate of SiO₂ (B₂O₃/SiO₂) is preferably from 0 to 0.15. A lower limit of this ratio is more preferably more than 0, further preferably 0.03, further more preferably 0.05. An upper limit of this ratio is more preferably 0.14, further preferably 0.13, further more preferably 0.12.

In view of achieving high dispersion while achieving a low refractive index, and reducing ΔP_{g, F}, a total content rate of SiO₂, TiO₂, and Na₂O (SiO₂+TiO₂+Na₂O) is 75% or more. A lower limit of this total content rate is preferably 84%, more preferably 90%, further preferably 94%. An upper limit of this total content rate is preferably 99%, more preferably 98%, further preferably 96%.

In view of achieving high dispersion and reducing ΔP_{g, F}, a total content rate of SiO₂ and Na₂O (a total content rate of SiO₂+Na₂O) is from 55% to 85%. A lower limit of this total content rate is preferably 76%, more preferably 76.5%, further preferably 77%. An upper limit of this total content rate is preferably 80%, more preferably 79.5%, further preferably 79%.

In view of achieving high dispersion and reducing ΔP_{g, F}, a ratio of TiO₂ to Na₂O (TiO₂/Na₂O) is from 0.3 to 1.6. A lower limit of this ratio is preferably 0.40, more preferably 0.77, further preferably 0.80. An upper limit of this ratio is preferably 1.0, more preferably 0.97, further preferably 0.96, further more preferably 0.94.

In view of achieving high dispersion while achieving a low refractive index, and reducing ΔP_{g, F}, a ratio of a content rate of Na₂O to a total content rate of SiO₂, TiO₂, and Na₂O (SiO₂+TiO₂+Na₂O) (Na₂O/(SiO₂+TiO₂+Na₂O)) is preferably from 0.18 to 0.40. A lower limit of this ratio is preferably 0.19, more preferably 0.21, further preferably 0.23, further more preferably 0.25. An upper limit of this ratio is preferably 0.39, more preferably 0.37, further preferably 0.35, further more preferably 0.27.

In addition, as required, for the purpose of clarifying, coloring, decoloring, fine adjustment of an optical constant value, or the like, each of a fining agent, a coloring agent, and a defoaming agent that are publicly known may be added to the glass composition by an appropriate amount with an upper limit of 0.5% by an outer percentage. Here, in a case of a fining agent, for example, the outer percentage is obtained in the following manner. When a total content rate of a mass of all the glass components except the fining agent in terms of oxides is 100%, a mass of the fining agent expressed by mass % with respect to a total of a mass of all the glass components except the fining agent in terms of oxides and a mass of the fining agent (a mass of the fining agent/(a mass of all the glass components except the fining agent in terms of oxides+the fining agent)) is the outer percentage. The definitions of the outer percentages of the coloring agent and the defoaming agent are similar to the above. Specifically, the defoaming agent is tin oxide (SnO₂). Other components may be added as long as the effect of the optical glass according to the present embodiment can be exerted, not limiting to the above-mentioned components.

It is preferred that a high-purity material having a low content rate of impurities be used as a raw material for each of the components described above. For example, as one, two, or more of the SiO₂ raw material and the B₂O₃ raw material, a high-purity material is preferably used. The high-purity material indicates a material including 99.85 mass % or more of a concerned component. By using the high-purity material, a content rate of impurities is reduced. As a result, an inner transmittance of light having a wavelength of 400 nm or less is likely to be increased, for example.

Next, description is made on physical properties and the like of the optical glass according to the present embodiment.

A suitable example of a refractive index (n_{d}) with respect to a d-line of the optical glass according to the present embodiment includes a refractive index that falls within a range from 1.58 to 1.71 with a lower limit of 1.58 and an upper limit of 1.71. The lower limit of the refractive index is more preferably 1.60, further preferably 1.605, further more preferably 1.61. The upper limit of the refractive index is more preferably 1.705, further preferably 1.70, further more preferably 1.634.

A suitable example of an abbe number (ν_{d}) of the optical glass according to the present embodiment includes an abbe number that falls within a range from 25 to 42 with a lower limit of 25 and an upper limit of 42. The lower limit of the abbe number is preferably 28, more preferably 28.5, further preferably 29. The upper limit of the abbe number is more preferably 41, further preferably 40.

The refractive index (n_{d}) with respect to the d-line and the abbe number (ν_{d}) of the optical glass according to the present embodiment are values obtained through measurement by the V-block method or the minimum deviation method.

Further, a value (ΔP_{g, F}) indicating abnormal dispersibility of the optical glass according to the present embodiment is preferably 0.0060 or less, more preferably 0.0040 or less, further preferably 0.0020 or less.

Further, the optical glass according to the present embodiment preferably has physical properties, specifically, the refractive index (n_{d}) of 1.58 to 1.71, the abbe number (ν_{d}) of 25 to 42, and the value (ΔP_{g, F}) indicating abnormal dispersibility of 0.0060 or less.

Moreover, a partial dispersion ratio (P_{g, F}) of the optical glass according to the present embodiment is preferably 0.603 or less, more preferably 0.600 or less, further preferably 0.590 or less, further more preferably 0.585 or less.

Note that the refractive index, the abbe number, the value indicating abnormal dispersibility, and the partial dispersion ratio can be measured in accordance with a method described in Examples, which are described later.

As described above, the optical glass according to the present embodiment can reduce the value (ΔP_{g, F}) indicating abnormal dispersibility while achieving a low refractive index (a small refractive index (n_{d})) and high dispersion (a small abbe number (ν_{d})). Moreover, when such an optical glass is used, for example, an optical system with chromatic aberration or other aberration that is satisfactorily corrected can be designed. The optical glass according to the present embodiment does not include a large amount of Nb₂O₅, which reduces the raw material costs, and hence can be provided at a low price.

Specific gravity (S_{g}) of the optical glass according to the present embodiment is preferably 3.10 or less, more preferably 3.08 or less, further preferably 3.06 or less, further more preferably 3.00 or less. The optical glass according to the present embodiment may have such low specific gravity, and hence can suitably be used as a material of a light-weighted optical element or the like.

A method of manufacturing the optical glass according to the present embodiment is not particularly limited, and a publicly known method may be adopted. Further, suitable conditions can be selected for the manufacturing conditions as appropriate. For example, oxides, hydroxides, phosphate compounds (phosphates, orthophosphates, and the like), carbonates, sulfates, nitrates, fluorides, and the like that correspond to the respective raw materials described above are blended to obtain a target composition, melted at a temperature preferably from 1100 to 1500 degrees Celsius, more preferably from 1340 to 1400 degrees Celsius, uniformed by stirring, subjected to defoaming, poured in a mold, and molded. Such a manufacturing method or the like may be adopted. The optical glass thus obtained is processed to have a desired shape by performing re-heat pressing or the like as needed, and is subjected to polishing. With this, a desired optical element is obtained.

From a similar viewpoint, the method of manufacturing the optical glass according to the present embodiment includes at least a step of heating the raw materials of the optical glass at a temperature from 1340 to 1400 degrees Celsius. In the method, when 50 g of the raw materials of the optical glass are heated at a temperature from 1340 to 1400 degrees Celsius, a time period required for melting 50 g of the raw materials is preferably less than 15 minutes. The raw materials with such a melting time are used and heated at a temperature from 1340 to 1400 degrees Celsius, so that the optical glass with high quality can be manufactured with a satisfactory yield without mixing the remaining glass raw materials into the glass during the heating step.

From the above-mentioned viewpoint, the optical glass according to the present embodiment can suitably be used as, for example, an optical element included in optical equipment. Such an optical element includes a mirror, a lens, a prism, a filter, and the like. Examples of an optical system including the optical element described above include an objective lens, a condensing lens, an image forming lens, and an interchangeable camera lens. The optical system can suitably be used for various types of optical devices, for example, imaging devices such as a lens-interchangeable camera and a fixed lens camera, and microscope devices such as a fluorescence microscope and a multi-photon microscope. The optical device is not limited to the imaging device and the microscope described above, and also includes a telescope, a binocular, a laser range finder, a projector, and the like. However, the optical device is not limited thereto. One example of the above is described below.

### Imaging Device

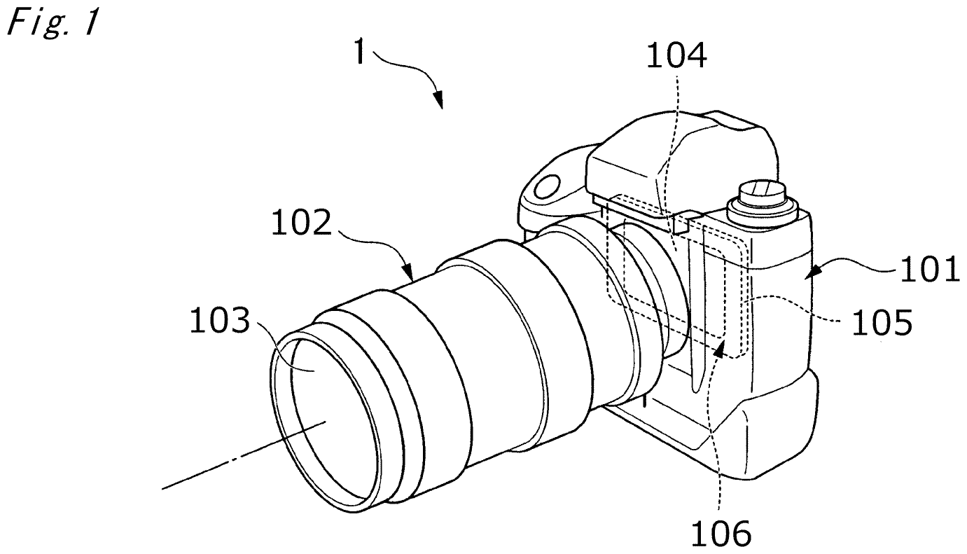

FIG. 1 is a perspective view illustrating one example of an optical device according to the present embodiment as an imaging device. An imaging device 1 is a so-called digital single-lens reflex camera (a lens-interchangeable camera), and a photographing lens 103 (an optical system) includes an optical element with the optical glass according to the present embodiment as a base material. A lens barrel 102 is mounted to a lens mount (not illustrated) of a camera body 101 in a removable manner. An image is formed with light, which passes through the lens 103 of the lens barrel 102, on a sensor chip (solid-state imaging elements) 104 of a multi-chip module 106 arranged on a back surface side of the camera body 101. The sensor chip 104 is a so-called bare chip such as a CMOS image sensor, and the multi-chip module 106 is, for example, a Chip On Glass (COG) type module including the sensor chip 104 being bare-chip-mounted on a glass substrate 105.

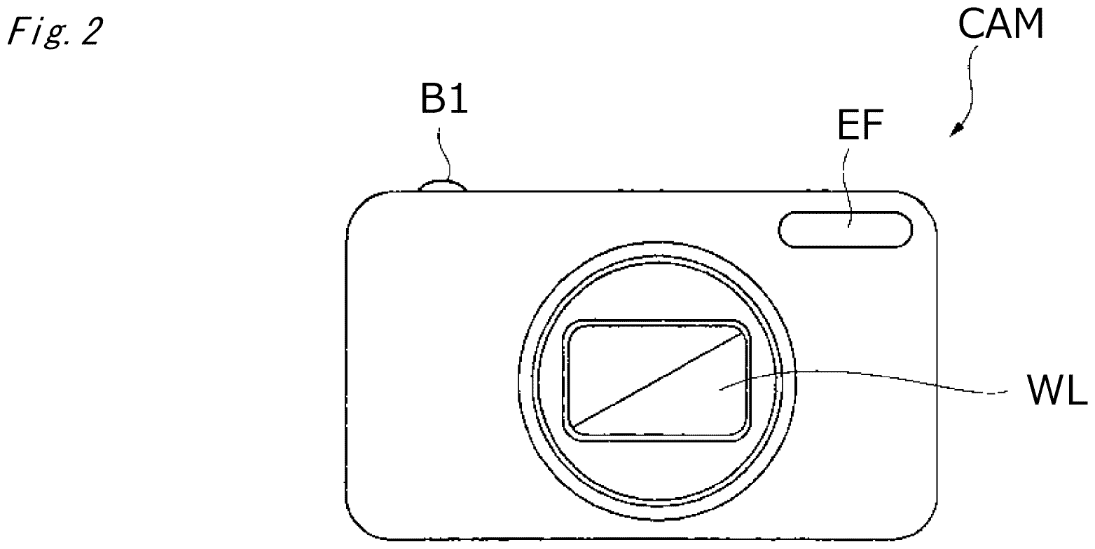

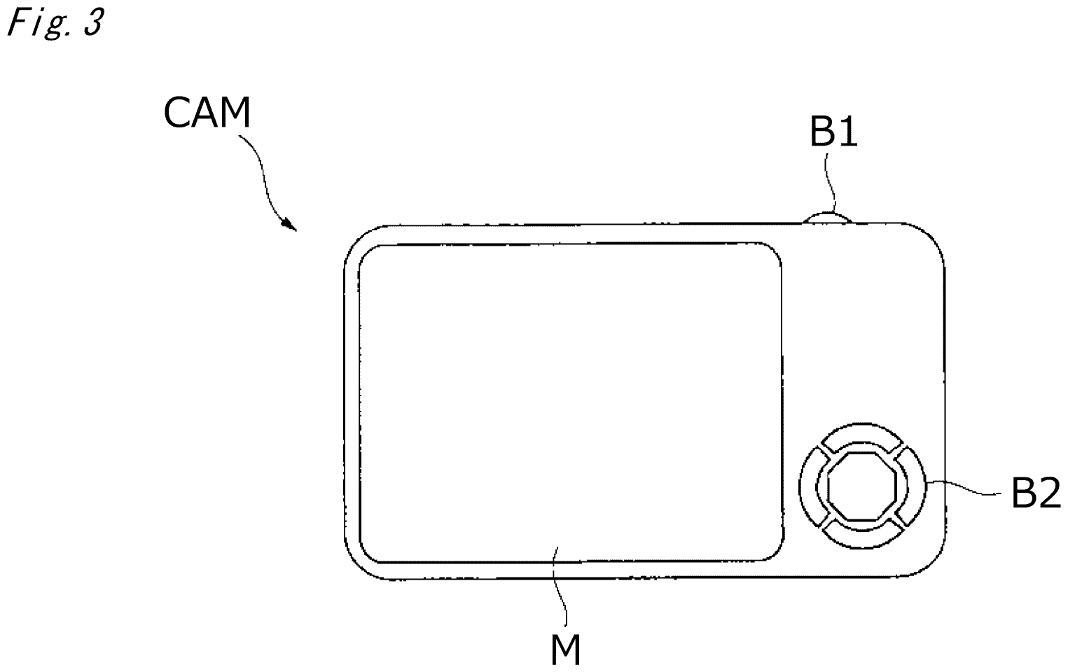

FIG. 2 and FIG. 3 are schematic diagrams illustrating another example of the optical device according to the present embodiment as an imaging device. FIG. 2 is a front view of an imaging device CAM, and FIG. 3 is a back view of the imaging device CAM. The imaging device CAM is a so-called digital still camera (a fixed lens camera), and a photographing lens WL (an optical system) includes an optical element with the optical glass according to the present embodiment as a base material.

When a power button (not illustrated) of the imaging device CAM is pressed, a shutter (not illustrated) of the photographing lens WL is opened, light from an object to be imaged (a body) is converged by the photographing lens WL, and forms an image on imaging elements arranged on an image surface. An object image formed on the imaging elements is displayed on a liquid crystal monitor M arranged on the back of the imaging device CAM. A photographer decides composition of the object image while viewing the liquid crystal monitor M, then presses down a release button B1, and captures the object image on the imaging elements. The object image is recorded and stored in a memory (not illustrated).

An auxiliary light emitting unit EF that emits auxiliary light in a case that the object to be imaged is dark and a function button B2 to be used for setting various conditions of the imaging device CAM and the like are arranged on the imaging device CAM.

A higher resolution, lower chromatic aberration, and a smaller size are demanded for the optical system to be used in such a digital camera or the like. In order to achieve such demands, it is effective to use glasses having optical dispersion properties different from each other as the optical system. In particular, the glass that achieves low dispersion and a high partial dispersion ratio (P_{g, F}) is highly demanded. From such a viewpoint, the optical glass according to the present embodiment is suitable as a member of such optical equipment. Note that, in addition to the imaging device described above, examples of the optical equipment to which the present embodiment is applicable include a projector and the like. In addition to the lens, examples of the optical element include a prism and the like.

### Microscope

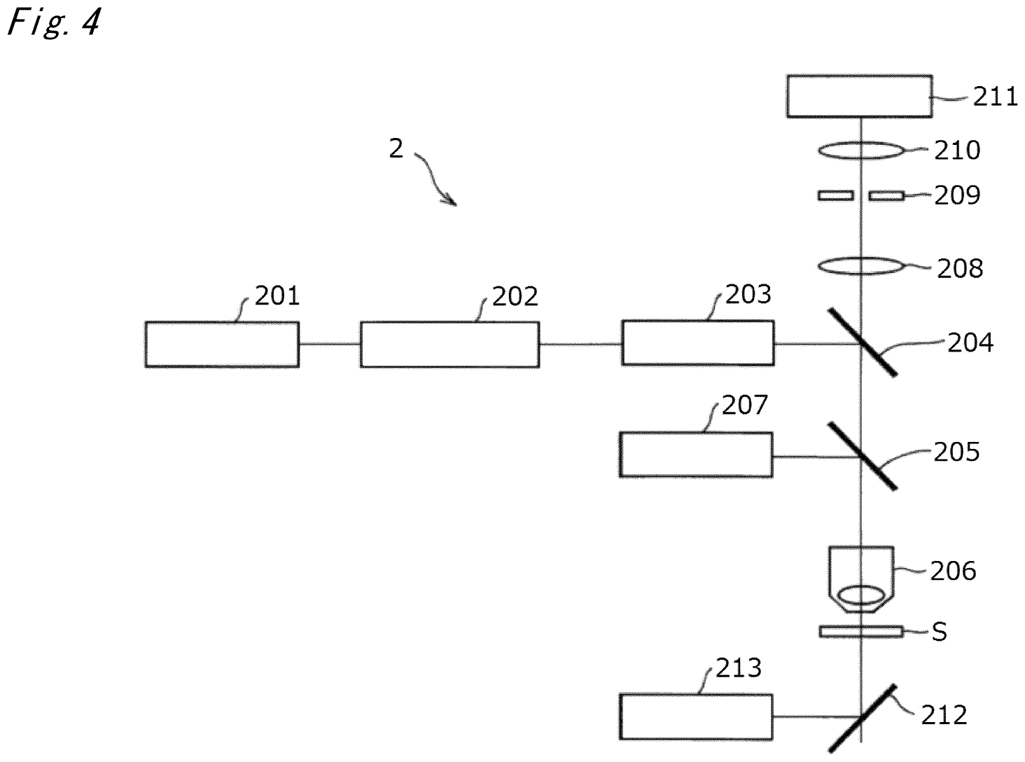

FIG. 4 is a block diagram illustrating an example of a configuration of a multi-photon microscope 2 according to the present embodiment. The multi-photon microscope 2 includes an objective lens 206, a condensing lens 208, and an image forming lens 210. At least one of the objective lens 206, the condensing lens 208, and the image forming lens 210 includes an optical element with the optical glass according to the present embodiment as a base material. Hereinafter, description is mainly made on the optical system of the multi-photon microscope 2.

A pulse laser device 201 emits ultrashort pulse light having, for example, a near infrared wavelength (approximately 1000 nm) and a pulse width of a femtosecond unit (for example, 100 femtoseconds). In general, ultrashort pulse light immediately after being emitted from the pulse laser device 201 is linearly polarized light that is polarized in a predetermined direction.

A pulse division device 202 divides the ultrashort pulse light, increases a repetition frequency of the ultrashort pulse light, and emits the ultrashort pulse light.

A beam adjustment unit 203 has a function of adjusting a beam diameter of the ultrashort pulse light, which enters from the pulse division device 202, to a pupil diameter of the objective lens 206, a function of adjusting convergence and divergence angles of the ultrashort pulse light in order to correct chromatic aberration (a focus difference) on an axis of a wavelength of light emitted from a sample S and the wavelength of the ultrashort pulse light, a pre-chirp function (group velocity dispersion compensation function) providing inverse group velocity dispersion to the ultrashort pulse light in order to correct the pulse width of the ultrashort pulse light, which is increased due to group velocity dispersion at the time of passing through the optical system, and the like.

The ultrashort pulse light emitted from the pulse laser device 201 have a repetition frequency increased by the pulse division device 202, and is subjected to the above-mentioned adjustments by the beam adjustment unit 203. The ultrashort pulse light emitted from the beam adjustment unit 203 is reflected on a dichroic mirror 204 in a direction toward a dichroic mirror, passes through a dichroic mirror 205, is converged by the objective lens 206, and is radiated to the sample S. At this time, an observation surface of the sample S may be scanned with the ultrashort pulse light through use of scanning indicates (not illustrated).

For example, when the sample S is subjected to fluorescence observation, a fluorescent pigment by which the sample S is dyed is subjected to multi-photon excitation in an irradiated region with the ultrashort pulse light and the vicinity thereof on the sample S, and fluorescence having a wavelength shorter than an infrared wavelength of the ultrashort pulse light (hereinafter, also referred to “observation light”) is emitted.

The observation light emitted from the sample S in a direction toward the objective lens 206 is collimated by the objective lens 206, and is reflected on the dichroic mirror 205 or passes through the dichroic mirror 205 depending on the wavelength.

The observation light reflected on the dichroic mirror 205 enters a fluorescence detection unit 207. For example, the fluorescence detection unit 207 is formed of a barrier filter, a photo multiplier tube (PMT), or the like, receives the observation light reflected on the dichroic mirror 205, and outputs an electronic signal depending on an amount of the light. The fluorescence detection unit 207 detects the observation light over the observation surface of the sample S, in conformity with the ultrashort pulse light scanning on the observation surface of the sample S.

Note that all the observation light emitted from the sample S in a direction toward the objective lens 206 may be detected by a fluorescence detection unit 211 by excluding the dichroic mirror 205 from the optical path. In such a case, the observation light passes through the scanning means (not illustrated), passes through the dichroic mirror 204, is converged by the condensing lens 208, passes through a pinhole 209 provided at a position substantially conjugate to a focal position of the objective lens 206, passes through the image forming lens 210, and enters the fluorescence detection unit 211.

For example, the fluorescence detection unit 211 is formed of a barrier filter, a PMT, or the like, receives the observation light forming an image on a reception surface of the fluorescence detection unit 211 by the image forming lens 210, and outputs an electronic signal depending on an amount of the light. The fluorescence detection unit 211 detects the observation light over the observation surface of the sample S, in conformity with the ultrashort pulse light scanning on the observation surface of the sample S.

Note that all the observation light emitted from the sample S in a direction toward the objective lens 206 may be detected by the fluorescence detection unit 211 by excluding the dichroic mirror 205 from the optical path.

The observation light emitted from the sample S in a direction opposite to the objective lens 206 is reflected on a dichroic mirror 212, and enters a fluorescence detection unit 213. The fluorescence detection unit 113 is formed of, for example, a barrier filter, a PMT, or the like, receives the observation light reflected on the dichroic mirror 212, and outputs an electronic signal depending on an amount of the light. The fluorescence detection unit 213 detects the observation light over the observation surface of the sample S, in conformity with the ultrashort pulse light scanning on the observation surface of the sample S.

The electronic signals output from the fluorescence detection units 207, 211, and 213 are input to, for example, a computer (not illustrated). The computer is capable of generating an observation image, displaying the generated observation image, storing data on the observation image, based on the input electronic signals.

### Cemented Lens

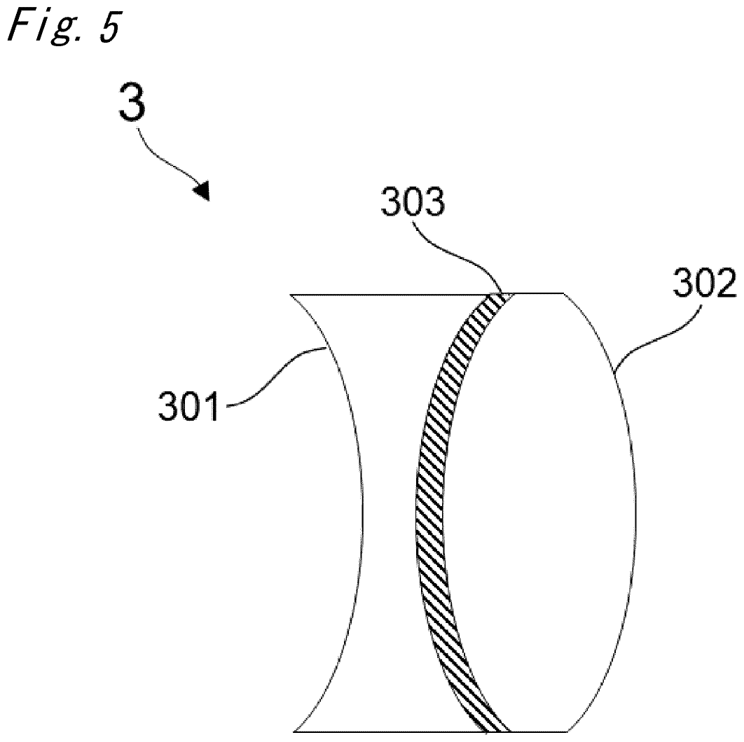

FIG. 5 is a schematic diagram illustrating one example of a cemented lens according to the present embodiment. A cemented lens 3 is a compound lens including a first lens element 301 and a second lens element 302. The optical glass according to the present embodiment is used as at least one of the first lens element and the second lens element. The first lens element and the second lens element are joined through intermediation with a joining member 303. As the joining member 303, a publicly known adhesive agent or the like may be used. Note that “the lens element” indicates each lens forming a single lens or a cemented lens.

The cemented lens according to the present embodiment is effective in view of correction of chromatic aberration, and can be used suitably for the optical element, the optical system, and the optical device that are described above and the like. Furthermore, the optical system including the cemented lens can be used suitably for, especially, an interchangeable camera lens and an optical device. Note that, in the aspect described above, description is made on the cemented lens using the two lens elements, but the present invention is not limited thereto, and a cemented lens using three or more lens elements may be used. When the cemented lens uses three or more lens elements, it is only required that at least one of the three or more lens elements be formed by using the optical glass according to the present embodiment.

### EXAMPLES

Next, description is made on Examples in the present invention and Comparative Example. Note that the present invention is not limited thereto.

Each of the tables shows a chemical composition of each component based on a chemical composition of each component by mass % in terms of oxides, the refractive index (n_{d}), the abbe number (ν_{d}), the specific gravity (S_{g}), the partial dispersion ratio (P_{g, F}), the value (ΔP_{g, F}) indicating abnormal dispersibility, and devitrification resistance stability of each of the optical glasses in Examples and Comparative Example.

### Production of Optical Glasses

The optical glasses in Examples and Comparative Example were produced by the following procedures. First, in order to obtain the chemical composition (mass %) shown in each of the tables, the glass raw materials such as oxides, carbonates, and nitrates were weighted so that the weight of the oxides after melting was 100 g. Next, the weighed raw materials were mixed and put in a platinum crucible having an inner capacity of about 100 mL, melted for about 70 minutes at a temperature of from 1250 to 1400 degrees Celsius, and uniformed by stirring. After clarifying, the resultant was poured in a mold or the like, annealed, and molded. In this manner, each of the samples was obtained. In Example 19, the resultant was melted for about 40 minutes at a temperature of 1300 degrees Celsius, and then dropped into water to produce frit. The frit was melted for 30 minutes at a temperature of 1300 degrees Celsius, uniformed by stirring, poured in a mold or the like, annealed, and molded. With this, the sample was obtained.

### Evaluation on Physical Properties

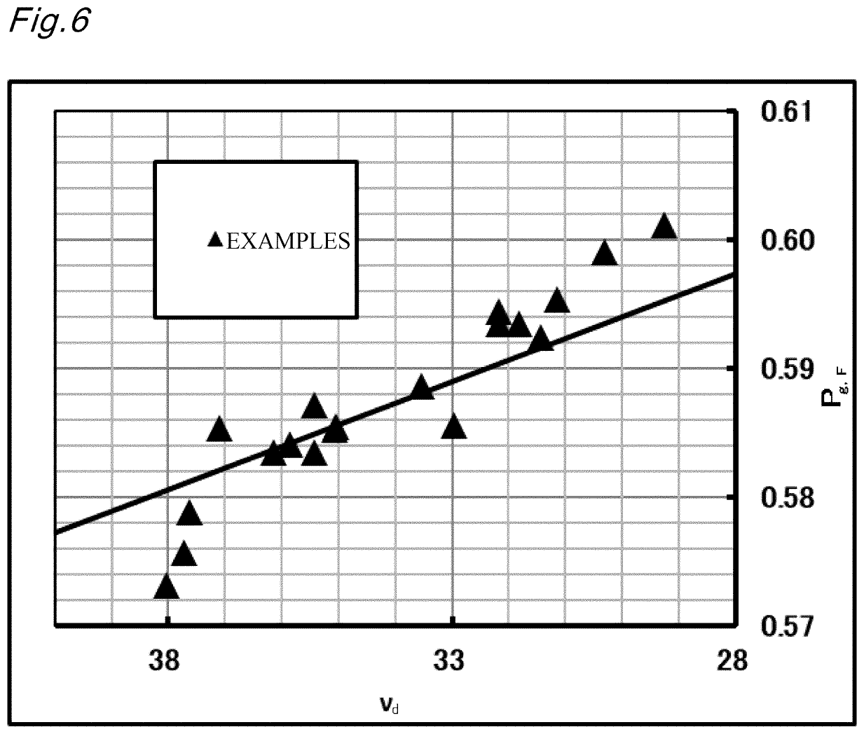

FIG. 6 is a graph in which P_{g, F} and ν_{d} in each example and each comparative example are plotted.

Refractive Index (n_{d}) and Abbe Number (ν_{d})

The refractive index (n_{d}) and the abbe number (ν_{d}) in each sample were measured and calculated by the V-block method in each of Examples 1 to 4, 6, and 8, and were measured and calculated by the minimum deviation method in each of Examples 5, 7, and 9 to 19. n_{d} indicates a refractive index of the glass with respect to light of 587.562 nm. ν_{d} was obtained based on Expression (1) given below. n_{c} and n_{F} indicate refractive indexes of the glass with respect to light having a wavelength of 656.273 nm and light having a wavelength of 486.133 nm, respectively.

ν_{d}=(n_{d}−1)/(n_{F}−n_{c}) (1)

A value of a refractive index was truncated to the sixth decimal place.

### Specific Gravity (S_{g})

Specific gravity (S_{g}) of each of the samples was obtained by measuring a mass ratio with respect to pure water with an equal volume at 4 degrees Celsius by the Archimedes method.

### Devitrification Resistance Stability

Devitrification resistance stability in each of the samples was checked by subjecting the produced glass to abrasive machining and visually observing presence or absence of devitrification. In each of the tables, “presence of devitrification” indicates that a devitrification portion was observed in a sample, and “absence of devitrification” indicates that a devitrification portion was not observed in a sample.

### Partial Dispersion Ratio (P_{g, F})

The partial dispersion ratio (P_{g, F}) in each of the samples indicates a ratio of partial dispersion (n_{g}−n_{F}) to main dispersion (n_{F}−n_{c}), and was obtained based on Expression (2) given below. n_{g} indicates a refractive index of the glass with respect to light having a wavelength of 435.835 nm. A value of a partial dispersion ratio (P_{g, F}) was truncated to the fourth decimal place.

P_{g,F}=(n_{g}−n_{F})/(n_{F}−n_{c}) (2)

### Abnormal Dispersibility (ΔP_{g, F})

Abnormal dispersibility (ΔP_{g, F}) in each of the samples is indicated by deviation from a partial dispersion ratio standard line based on two reference glasses F2 and K7, as glasses having normal dispersibility. In other words, on a coordinate system indicating the partial dispersion ratio (P_{g, F}) with a vertical axis and the abbe number ν_{d} with a horizontal axis, a difference in vertical direction between a linear line connecting the two reference glasses and a value of a glass being a comparison target indicates deviation of the partial dispersion ratio, in other words, abnormal dispersibility (ΔP_{g, F}). On the coordinate system described above, when the value of the partial dispersion ratio is located above the linear line connecting the reference glasses, the glass shows positive abnormal dispersibility (+ΔP_{g, F}). When the value is located below the linear line, the glass shows negative abnormal dispersibility (−ΔP_{g, F}). Note that the abbe numbers ν_{d} and the partial dispersion ratios (P_{g, F}) in F2 and K7 were as follows.
F2: the abbe number ν_{d}=36.33, the partial dispersion ratio (P_{g, F})=0.5834
K7: the abbe number ν_{d}=60.47, the partial dispersion ratio (P_{g, F})=0.5429
   A value of abnormal dispersibility (ΔP_{g, F}) was truncated to the fourth decimal place.

ΔP_{g,F}=P_{g,F}−(−0.0016777×ν_{d}+0.6443513) (3)

For the optical glasses in Examples and Comparative Example, a composition of each component by mass % in terms of oxides, mass % of the F component by an outer percentage, and evaluation results on respective physical properties are shown in Tables 1 to 5.

TABLE 1

| | EX- | EX- | EX- | EX- | EX- | EX- |
|---|---|---|---|---|---|---|
| | AMPLE | AMPLE | AMPLE | AMPLE | AMPLE | AMPLE |
| | 1 | 2 | 3 | 4 | 5 | 6 |
| SiO₂ | 48.72 | 48.71 | 42.79 | 44.57 | 52.27 | 50.49 |
| B₂O₃ | | | | | | |
| Al₂O₃ | | | | | | |
| Na₂O | 27.95 | 22.03 | 33.88 | 33.88 | 25.58 | 22.03 |
| K₂O | | | | | | |
| BaO | | | | | | |
| CaO | | | | | | |
| MgO | | | | | | |
| SrO | | | | | | |
| ZnO | | | | | | |
| ZrO₂ | | | | | | |
| TiO₂ | 11.49 | 11.49 | 11.49 | 15.04 | 22.15 | 27.48 |
| Nb₂O [symbol] | 11.84 | 17.77 | 11.84 | 6.51 | | |
| WO₃ | | | | | | |
| Ta₂O [symbol] | | | | | | |
| La₂O₃ | | | | | | |
| Gd₂O₃ | | | | | | |
| Y₂O₃ | | | | | | |
| Sb₂O [symbol] | | | | | | |
| TOTAL (MASS %) | 100 | 100 | 100 | 100 | 100 | 100 |
| [symbol] COMPONENT | | | | | | |
| (MASS % BY OUTER | | | | | | |
| PERCENTAGE) | | | | | | |
| n_{d} | 1.611863 | 1.646210 | 1.611793 | 1.607769 | 1.621830 | 1.651345 |
| ν_{d} | 38.04 | 35.04 | 37.62 | 37.72 | 36.14 | 32.97 |
| S [symbol] | 2.77 | 2.85 | 2.79 | 2.75 | 2.71 | 2.74 |
| P [symbol] | 0.5731 | 0.5854 | 0.5788 | 0.5757 | 0.5834 | 0.5856 |
| [symbol] P [symbol] | −0.0074 | −0.0002 | −0.0024 | −0.0054 | −0.0003 | −0.0035 |
| DEVITRIFICATION | ABSENCE | ABSENCE | ABSENCE | ABSENCE | ABSENCE | ABSENCE |
| RESISTANCE | OF | OF | OF | OF | OF | OF |
| STABILITY | DEVITRI- | DEVITRI- | DEVITRI- | DEVITRI- | DEVITRI- | DEVITRI- |
| | FICATION | FICATION | FICATION | FICATION | FICATION | FICATION |
| (B₂0 [symbol] + K₂0 + Al₂0₃)/Na₂0 | 0 | 0 | 0 | 0 | 0 | 0 |
| K₂0 + Al₂0 [symbol] | 0 | 0 | 0 | 0 | 0 | 0 |
| Mg0 + Ca0 + Sr0 + Ba0 | 0 | 0 | 0 | 0 | 0 | 0 |
| La₂0 [symbol] + Gd₂0₃ + Y₂0 [symbol] | 0 | 0 | 0 | 0 | 0 | 0 |
| Li₂0 + Na₂0 + K₂0 | 27.95 | 22.03 | 33.88 | 33.88 | 25.58 | 22.03 |
| B₂0₃/Si0₂ | 0 | 0 | 0 | 0 | 0 | 0 |
| Si0₂ + Ti0₂ + Na₂0 | 88.16 | 82.23 | 88.16 | 93.49 | 100 | 100 |
| Na₂0/(Si0₂ + Ti0₂ + Na₃0) | 0.317 | 0.268 | 0.384 | 0.362 | 0.256 | 0.220 |
| Si0 [symbol] + Na₂0 | 76.67 | 70.74 | 76.67 | 78.45 | 77.85 | 72.52 |
| Ti0 [symbol] /Na₂0 | 0.41 | 0.52 | 0.34 | 0.44 | 0.87 | 1.25 |

[symbol]

indicates data missing or illegible when filed

TABLE 2

| | EXAMPLE 7 | EXAMPLE 8 | EXAMPLE 9 | EXAMPLE 10 | EXAMPLE 11 |
|---|---|---|---|---|---|
| SiO₂ | 50.49 | 46.94 | 38.65 | 38.64 | 38.65 |
| B₂O₃ | | | | | |
| Al₂O₃ | | | | | |
| Na₂O | 19.66 | 23.22 | 27.95 | 22.03 | 22.03 |
| K₂O | | | | | |
| Li₂O | | | | | |
| BaO | | | | | |
| CaO | | | | | |
| MgO | | | | | |
| SrO | | | | | |
| ZnO | | | 11.84 | 17.77 | 5.92 |
| ZrO₂ | | | | | 11.84 |
| TiO₂ | 29.85 | 29.84 | 21.56 | 21.56 | 21.56 |
| Nb₂O₅ | | | | | |
| WO₃ | | | | | |
| Ta₂O₅ | | | | | |
| La₂O₃ | | | | | |
| Gd₂O₃ | | | | | |
| Y₂O₃ | | | | | |
| Sb₂O₃ | | | | | |
| TOTAL (MASS %) | 100 | 100 | 100 | 100 | 100 |
| F COMPONENT (MASS % | | | | | |
| BY [symbol] PERCENTAGE) | | | | | |
| n_{d} | 1.677407 | 1.669793 | 1.651380 | 1.673739 | 1.691642 |
| ν_{d} | 30.31 | 31.16 | 33.54 | 32.17 | 31.82 |
| S [symbol] | 2.78 | 2.78 | 2.92 | 3.03 | 3.01 |
| P_{g, F} | 0.5990 | 0.5954 | 0.5886 | 0.5944 | 0.5935 |
| [symbol] P_{g, F} | 0.0055 | 0.0033 | 0.0005 | 0.0040 | 0.0025 |
| DEVITRIFICATION | ABSENCE OF | ABSENCE OF | ABSENCE OF | ABSENCE OF | ABSENCE OF |
| RESISTANCE STABILITY | DEVITRIFI- | DEVITRIFI- | DEVITRIFI- | DEVITRIFI- | DEVITRIFI- |
| | CATION | CATION | CATION | CATION | CATION |
| (B₂O₃ + K₂O + Al₂O₃)/Na₂O | 0 | 0 | 0 | 0 | 0 |
| K₂O + Al₂O₃ | 0 | 0 | 0 | 0 | 0 |
| MgO + CaO + SrO + BaO | 0 | 0 | 0 | 0 | 0 |
| La₂O₃ + Gd₂O₃ + Y₂O₃ | 0 | 0 | 0 | 0 | 0 |
| Li₂O + Na₂O + K₂O | 19.66 | 23.22 | 27.95 | 22.03 | 22.03 |
| B₂O₃/SiO₂ | 0 | 0 | 0 | 0 | 0 |
| SiO₂ + TiO₂ + Na₂O | 100 | 100 | 88.16 | 82.23 | 82.24 |
| Na₂O/(SiO₂ + TiO₂ + Na₂O) | 0.197 | 0.232 | 0.317 | 0.268 | 0.268 |
| SiO₂ + Na₂O | 70.15 | 70.16 | 66.60 | 60.67 | 60.68 |
| TiO₂/Na₂O | 1.52 | 1.29 | 0.77 | 0.98 | 0.98 |

[symbol]

indicates data missing or illegible when filed

TABLE 3

| | EXAMPLE 12 | EXAMPLE 13 | EXAMPLE 14 | EXAMPLE 15 | EXAMPLE 16 |
|---|---|---|---|---|---|
| SiO₂ | 38.65 | 47.27 | 38.58 | 43.56 | 52.27 |
| B₂O₃ | | 5.00 | | | 3.00 |
| Al₂O₃ | | | | | |
| Na₂O | 22.03 | 25.68 | 21.99 | 20.64 | 22.58 |
| K₂O | | | | | |
| Li₂O | | | | | |
| BaO | | | | 1.12 | |
| CaO | | | | 1.11 | |
| MgO | | | | 1.12 | |
| SrO | | | | 1.12 | |
| ZnO | | | 13. 01 | | |
| ZrO₂ | 11.84 | | | | |
| TiO₂ | 21.56 | 22.15 | 21.52 | 31.33 | 22.16 |
| Nb₂O₅ | | | | | |
| WO₃ | | | 1.18 | | |
| Ta₂O₅ | 5.92 | | | | |
| La₂O₃ | | | 1.18 | | |
| Gd₂O₃ | | | 1.18 | | |
| Y₂O₃ | | | 1.18 | | |
| Sb₂O₃ | | | 0.18 | | |
| TOTAL (MASS %) | 100 | 100 | 100 | 100 | 100 |
| F COMPONENT (MASS % | | | | | |
| BY [symbol] PERCENTAGE) | | | | | |
| n_{d} | 1.696557 | 1.631971 | 1.677648 | 1.701442 | 1.629326 |
| ν_{d} | 31.45 | 35.43 | 32.17 | 29.26 | 35.42 |
| S [symbol] | 3.05 | 2.73 | 3.04 | 2.87 | 2.71 |
| P_{g, F} | 0.5924 | 0.5872 | 0.5935 | 0.6011 | 0.5834 |
| [symbol] P_{g, F} | 0.0008 | 0.0023 | 0.0031 | 0.0058 | −0.0015 |
| DEVITRIFICATION | ABSENCE OF | ABSENCE OF | ABSENCE OF | ABSENCE OF | ABSENCE OF |
| RESISTANCE STABILITY | DEVITRIFI- | DEVITRIFI- | DEVITRIFI- | DEVITRIFI- | DEVITRIFI- |
| | CATION | CATION | CATION | CATION | CATION |
| (B₂O₃ + K₂O + Al₂O₃)/Na₂O | 0 | 0.196 | 0 | 0 | 0.133 |
| K₂O + Al₂O₃ | 0 | 0 | 0 | 0 | 0 |
| MgO + CaO + SrO + BaO | 0.000 | 0.000 | 0.000 | 4.470 | 0.000 |
| La₂O₃ + Gd₂O₃ + Y₂O₃ | 0.00 | 0.00 | 3.54 | 0.00 | 0.00 |
| Li₂O + Na₂O + K₂O | 22.03 | 25.58 | 21.99 | 20.64 | 22.58 |
| B₂O₃/SiO₂ | 0.00 | 0.11 | 0.00 | 0.00 | 0.06 |
| SiO₂ + TiO₂ + Na₂O | 82.24 | 95.00 | 82.09 | 96.53 | 97.00 |
| Na₂O/(SiO₂ + TiO₂ + Na₂O) | 0.268 | 0.269 | 0.268 | 0.216 | 0.233 |
| SiO₂ + Na₂O | 60.68 | 72.85 | 60.57 | 64.20 | 74.85 |
| TiO₂/Na₂O | 0.98 | 0.87 | 0.98 | 1.52 | 0.98 |

[symbol]

indicates data missing or illegible when filed

TABLE 4

| | EXAMPLE 17 | EXAMPLE 18 | EXAMPLE 19 |
|---|---|---|---|
| SiO₂ | 49.77 | 46.34 | 47.77 |
| B₂O₃ | | | |
| Al₂O₃ | 1.00 | | |
| Na₂O | 24.68 | 26.08 | 25.72 |
| K₂O | 1.00 | | 4.39 |
| Li₂O | 1.50 | | |
| BaO | | | |
| CaO | | | |
| MgO | | | |
| SrO | | | |
| ZnO | | | |
| ZrO₂ | | 6.00 | |
| TiO₂ | 22.15 | 21.56 | 22.10 |
| Nb₂O₅ | | | |
| WO₃ | | | |
| Ta₂O₅ | | | |
| La₂O₃ | | | |
| Gd₂O₃ | | | |
| Y₂O₃ | | | |
| Sb₂O₃ | | 0.02 | 0.02 |
| TOTAL (MASS %) | 100 | 100 | 100 |
| F COMPONENT (MASS % | | | 5.30 |
| BY [symbol] PERCENTAGE) | | | |
| n_{d} | 1.629527 | 1.642499 | 1.599624 |
| ν_{d} | 35.86 | 35.06 | 37.11 |
| S [symbol] | 2.71 | 2.80 | 2.73 |
| P_{g, F} | 0.5841 | 0.5852 | 0.5853 |
| [symbol] P_{g, F} | −0.0001 | −0.0004 | 0.0033 |
| DEVITRIFICATION | ABSENCE OF | ABSENCE OF | ABSENCE OF |
| RESISTANCE STABILITY | DEVITRIFI- | DEVITRIFI- | DEVITRIFI- |
| | CATION | CATION | CATION |
| (B₂O₃ + K₂O + Al₂O₃)/Na₂O | 0.081 | 0 | 0.171 |
| K₂O + Al₂O₃ | 2.00 | 0 | 4.39 |
| MgO + CaO + SrO + BaO | 0 | 0 | 0 |
| La₂O₃ + Gd₂O₃ + Y₂O₃ | 0 | 0 | 0 |
| Li₂O + Na₂O + K₂O | 27.08 | 26.08 | 30.11 |
| B₂O₃/SiO₂ | 0 | 0 | 0 |
| SiO₂ + TiO₂ + Na₂O | 96.50 | 93.98 | 95.59 |
| Na₂O/(SiO₂ + TiO₂ + Na₂O) | 0.255 | 0.278 | 0.269 |
| SiO₂ + Na₂O | 74.35 | 72.42 | 73.49 |
| TiO₂/Na₂O | 0.90 | 0.83 | 0.86 |

[symbol]

indicates data missing or illegible when filed

TABLE 5

| | COMPARATIVE |
|---|---|
| | EXAMPLE 1 |
| SiO₂ | 32.65 |
| B₂O₃ | |
| La₂O₃ | |
| Al₂O₃ | |
| Na₂O | 28.03 |
| K₂O | |
| Li₂O | |
| BaO | |
| CaO | |
| SrO | |
| MgO | |
| SrO | |
| ZnO | |
| ZrO₂ | 11.84 |
| TiO₂ | 21.56 |
| Nb₂O₅ | |
| WO₃ | |
| Ta₂O₅ | 5.92 |
| La₂O₃ | |
| Gd₂O₃ | |
| Y₂O₃ | |
| Sb₂O₃ | |
| TOTAL (MASS %) | 100 |
| F COMPONENT (MASS % | |
| BY [symbol] PERCENTAGE) | |
| n_{d} | NOT MEASURABLE |
| ν_{d} | |
| S [symbol] | |
| P_{g, F} | |
| [symbol] P_{g, F} | |
| DEVITRIFICATION | PRESENCE OF |
| RESISTANCE STABILITY | DEVITRIFICATION |
| (B₂O₃ + K₂O + Al₂O₃)/Na₂O | 0 |
| K₂O + Al₂O₃ | 0 |
| MgO + CaO + SrO + BaO | 0 |
| La₂O₃ + Gd₂O₃ + Y₂O₃ | 0 |
| Li₂O + Na₂O + K₂O | 28.03 |
| B₂O₃/SiO₂ | 0 |
| SiO₂ + TiO₂ + Na₂O | 82.24 |
| Na₂O/(SiO₂ + TiO₂ + Na₂O) | 0.341 |
| SiO₂ + Na₂O | 60.68 |
| TiO₂/Na₂O | 0.77 |

[symbol]

indicates data missing or illegible when filed

In Comparative Example 1, devitrification was confirmed in the produced glass. Thus, measurement of an optical constant was not performed.

From above, it was confirmed that the optical glasses in the present examples had low refractive indexes (n_{d}), small abbe numbers (ν_{d}), and small ΔP_{g, F} values, and were excellent in devitrification resistance stability. Further, low specific gravity was confirmed, which contributed weight reduction of the optical system.

What is claimed is:

1. An optical glass comprising, by mass %:
33 to 60% of a content rate of SiO₂;
10 to 35% of a content rate of TiO₂; and
15 to 40% of a content rate of Na₂O, wherein
a total content rate of SiO₂, TiO₂, and Na₂O (SiO₂+TiO₂+Na₂O) is 95.00% or more and 99% or less.

2. The optical glass according to claim 1, wherein, by mass %:
10 to 32% of a content rate of TiO₂.

3. The optical glass according to claim 1, wherein, by mass %:
a total content rate of SiO₂ and Na₂O (SiO₂+Na₂O) is from 55% to 85%.

4. The optical glass according to claim 3, wherein, by mass %:
a total content rate of SiO₂ and Na₂O (SiO₂+Na₂O) is from 76.67% to 85%.

5. The optical glass according to claim 1, wherein
by mass %, a content rate of a mass of F (fluorine) by an outer percentage with respect to a total mass of glass in terms of an oxide-converted composition is more than 0% and 15% or less.

6. The optical glass according to claim 1, wherein
by mass %, a content rate of Sb₂O₃ is from 0% to 1%.

7. The optical glass according to claim 1, wherein, by mass %:
a content rate of B₂O₃ is from 0 to 10%,
a content rate of La₂O₃ is from 0 to 5%,
a content rate of Gd₂O₃ is from 0 to 5%,
a content rate of Y₂O₃ is from 0 to 5%,
a content rate of ZrO₂ is from 0 to 20%,
a content rate of Nb₂O₅ is from 0 to 25%,
a content rate of MgO is from 0 to 5%,
a content rate of Ta₂O₅ is from 0 to 10%,
a content rate of ZnO is from 0 to 25%,
a content rate of BaO is from 0 to 5%,
a content rate of CaO is from 0 to 5%,
a content rate of SrO is from 0 to 5%,
a content rate of Al₂O₃ is from 0 to 5%,
a content rate of WO₃ is from 0 to 5%,
a content rate of Li₂O is from 0 to 5%, and
a content rate of K₂O is 0 or more and less than 10%.

8. The optical glass according to claim 1, wherein, by mass %:
a ratio of a content rate of TiO₂ to a content rate of Na₂O (TiO₂/Na₂O) is from 0.3 to 1.6.

9. The optical glass according to claim 1, wherein
each of elements Pb and As is substantially excluded.

10. The optical glass according to claim 1, wherein
each of elements Cd, Fe, Ni, Cr, Mn, Ag, Cu, Mo, Eu, and Au is substantially excluded.

11. The optical glass according to claim 1, wherein
a content rate of each of elements Pb, As, Cd, Fe, Ni, Cr, Mn, Ag, Cu, Mo, Eu, and Au is less than 40 ppm.

12. The optical glass according to claim 1, wherein, by mass %:
a ratio of a total content rate of B₂O₃, K₂O, and Al₂O₃ to a content rate of Na₂O ((B₂O₃+K₂O+Al₂O₃)/Na₂O) is from 0 to 0.5.

13. The optical glass according to claim 1, wherein, by mass %:
a total content rate of K₂O and Al₂O₃ (K₂O+Al₂O₃) is from 0 to 10%.

14. The optical glass according to claim 1, wherein, by mass %:
a total content rate of MgO, CaO, SrO, and BaO (MgO+CaO+SrO+BaO) is from 0 to 10%.

15. The optical glass according to claim 1, wherein, by mass %:
a total content rate of La₂O₃, Gd₂O₃, and Y₂O₃ (La₂O₃+Gd₂O₃+Y₂O₃) is from 0 to 10%.

16. The optical glass according to claim 1, wherein, by mass %:
a total content rate of Li₂O, Na₂O, and K₂O (Li₂O+Na₂O+K₂O) is from 15 to 40%.

17. The optical glass according to claim 1, wherein, by mass %:
a ratio of a content rate of B₂O₃ to a content rate of SiO₂ (B₂O₃/SiO₂) is from 0 to 0.15.

18. The optical glass according to claim 1, wherein, by mass %:
a ratio of a content rate of Na₂O to a total content rate of SiO₂, Na₂O, and TiO₂ (SiO₂+TiO₂+Na₂O) (Na₂O/(SiO₂+TiO₂+Na₂O)) is from 0.18 to 0.40.

19. The optical glass according to claim 1, wherein
a refractive index (n_{d}) with respect to a d-line is from 1.58 to 1.71.

20. The optical glass according to claim 1, wherein
an abbe number (ν_{d}) is from 25 to 42.

21. The optical glass according to claim 1, wherein
abnormal dispersibility (ΔP_{g, F}) is 0.0060 or less.

22. The optical glass according to claim 1, wherein
a partial dispersion ratio (P_{g, F}) is 0.603 or less.

23. The optical glass according to claim 1, wherein
specific gravity (S_{g}) is 3.10 or less.

24. An optical element using the optical glass according to claim 1.

25. An optical system comprising the optical element according to claim 24.

26. An interchangeable camera lens comprising the optical system according to claim 25.

27. A microscope objective lens comprising the optical system according to claim 25.

28. An optical device comprising the optical system according to claim 25.

29. A cemented lens comprising:
a first lens element; and
a second lens element, wherein
at least one of the first lens element and the second lens element comprises the optical glass according to claim 1.

30. An optical system comprising the cemented lens according to claim 29.

31. A microscope objective lens comprising the optical system according to claim 30.

32. An interchangeable camera lens comprising the optical system according to claim 30.

33. An optical device comprising the optical system according to claim 30.
